(19) United States
(12) Patent Application Publication
(10) Pub. No.: US 2026/0131391 A1
(43) Pub. Date: May 14, 2026

(54) REUSABLE OSCILLATING MULTI-TOOL AND RECIPROCATING SAW BLADES

(71) Applicant: James Dimond, Battle Creek, MI (US)

(72) Inventor: James Dimond, Battle Creek, MI (US)

(21) Appl. No.: 18/943,594

(22) Filed: Nov. 11, 2024

(51) Int. Cl. B23D 61/12; B23D 61/00; B23D 61/16; B23D 63/08; B23D 65/00

(52) U.S. Cl. CPC B23D 61/123; B23D 61/006; B23D 61/122; B23D 61/16; B23D 65/00; B23D 63/08

(57) ABSTRACT

An oscillating multi-tool blade may comprise a blade body and a bonded material for cutting teeth harder than the blade body. A total depth of the bonded material may be greater than one and a half times a height of original blade teeth. The bonded material may comprise high-speed steel, tungsten carbide, or a material harder than the blade body. The blade body may be designed for resharpening or reshaping of the cutting teeth after the original teeth are dull, worn down, or broken. The blade may be initially created with no teeth, allowing a user to create custom blade teeth. The blade body may be designed for replaceable teeth, a strip of teeth, or replaceable material for shaping new teeth. The blade may be cryofrozen. The blade may have a secondary coating for added blade life or friction reduction.

### CROSS-REFERENCE TO RELATED APPLICATIONS

This application claims the benefit of U.S. Provisional Application No. 63/537,497, filed on Sep. 9, 2023, the entire contents of which are hereby incorporated by reference.

### FIELD OF THE INVENTION

The present disclosure generally relates to power tool accessories, and more particularly to oscillating multi-tool and reciprocating saw blades designed for extended use through re-sharpening or creation of new teeth.

### BACKGROUND

Oscillating multi-tools and reciprocating saws are widely used in various applications, including construction, renovation, and DIY projects. The blades used in these tools are typically designed for single use, becoming ineffective once the teeth are dull or worn. This leads to frequent blade replacements, increasing costs and waste.

Conventional blades may incorporate harder materials for the cutting teeth, such as high-speed steel or tungsten carbide. However, these blades are generally designed with the minimum amount of harder material needed to form the teeth and bond to the blade body. Once the teeth are worn or damaged, the blades are typically discarded.

There exists a need for oscillating multi-tool and reciprocating saw blades that can be re-sharpened or have new teeth created multiple times, thereby extending the useful life of the blade and reducing waste.

### SUMMARY

The present disclosure describes oscillating multi-tool and reciprocating saw blades designed to be re-sharpened or have new teeth created multiple times. Various embodiments of the blades may include features such as excess hard material for re-sharpening, the ability to form custom teeth, and optional treatments or coatings for enhanced performance.

In one aspect, an oscillating multi-tool blade may comprise a blade body made of a first material and a strip of harder material bonded to the blade body. The strip of harder material may have a depth greater than one and a half times the height of original blade teeth.

In another aspect, a reciprocating saw blade may be designed for re-sharpening or reshaping of cutting teeth after the original teeth have been dulled, worn down, or broken. In yet another aspect, a blade may be provided without pre-formed teeth, allowing a user to create custom teeth geometries to suit specific needs. Additional features and advantages of the present disclosure will become apparent to those skilled in the art upon consideration of the following detailed description of the illustrative embodiments.

### BRIEF DESCRIPTION OF THE DRAWINGS

The features and advantages of aspects of the present invention will become more apparent from the detailed description set forth below when taken in conjunction with the claims and drawings, in which like reference numbers indicate identical or functionally similar elements. The detailed description particularly refers to the accompanying figures in which:

FIG. 1 is a perspective view of a blade without teeth, allowing for custom shaping and creation of teeth;

FIG. 2 is a perspective view of a conventional carbide oscillating multi-tool blade, showing a thin strip of carbide material;

FIG. 3 is a side view of a blade illustrating the blade height measurement and the extended depth of harder material;

FIG. 4 is a perspective view of a conventional bi-metal blade, showing the limited area of high-speed steel; and

FIG. 5 is a perspective view of a typical carbide oscillating multi-tool blade, illustrating the thin strip of carbide material used.

FIG. 6 is an illustration of various non-linear mating surfaces between a blade body and a harder material used for teeth.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains. In the following description, numerous specific details are set forth to clearly describe the embodiments disclosed herein. One skilled in the art may understand that some well known features have not been described in detail so as not to obscure the invention.

Reference is made herein to the attached drawings. Like reference numerals may be used in the drawings to indicate like or similar elements of the description. The figures are intended for representative purposes and should not be considered limiting.

The present disclosure can be understood more readily by reference to the following detailed description of the present disclosure and the examples included therein. Before the present articles, systems, devices, and/or methods are disclosed and described, it is to be understood that they are not limited to specific implementations unless otherwise specified, or to particular approaches unless otherwise specified, as such can, of course, vary. It is also to be understood that the terminology used herein is for the purpose of describing aspects only and is not intended to be limiting. Although any methods and materials similar or equivalent to those described herein can be used in the practice or testing of the present disclosure, example methods and materials are now described.

All publications mentioned herein are incorporated herein by reference to disclose and describe the methods and/or materials in connection with which the publications are cited.

### Definitions

It is to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this present disclosure belongs. In this specification and in the claims which follow, reference will be made to a number of terms which shall be defined herein.

As used in the specification and the appended claims, the singular forms “a,” “an,” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the present disclosure as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the present disclosure. Thus, if there are a variety of additional steps that can be performed it is understood that each of these additional steps can be performed with any specific aspect or combination of aspects of the methods of the present disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

The present disclosure relates to oscillating multi-tool and reciprocating saw blades designed for extended use through re-sharpening or creation of new teeth. These blades may provide cost savings and reduce waste by allowing multiple re-sharpenings or the formation of new teeth, rather than requiring disposal after a single use.

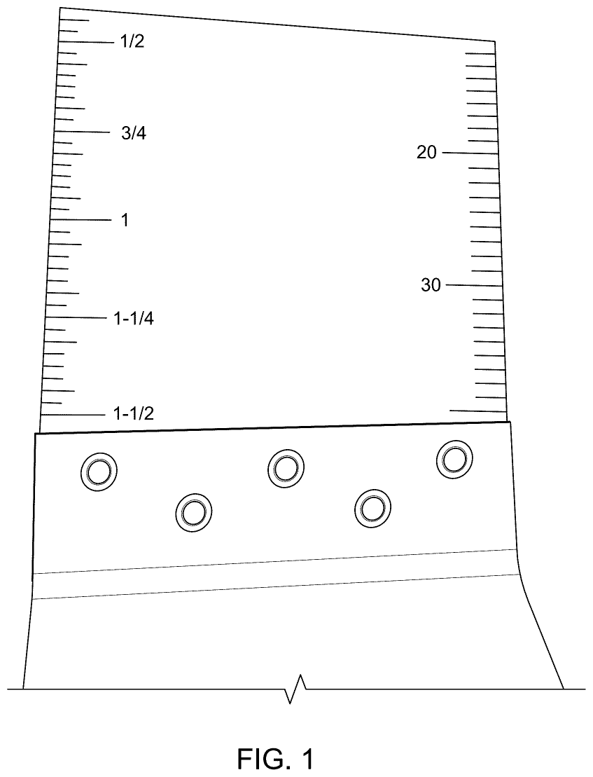

Referring now to FIG. 1, a blade 10 without pre-formed teeth is shown. The blade 10 may include a blade body 12 made of a first material, such as steel. A strip of harder material 14 may be bonded to the blade body 12. The harder material 14 may be, for example, tungsten carbide, high-speed steel, or another material more durable than the blade body material. The blade 10 may allow a user to shape and create custom teeth geometries to suit specific needs.

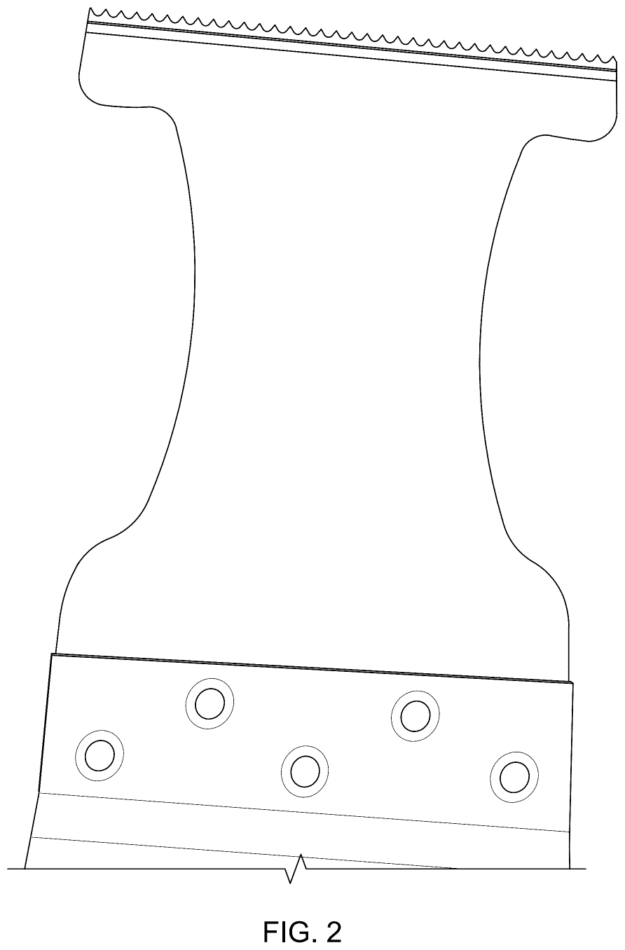

FIG. 2 illustrates a conventional carbide oscillating multi-tool blade 20 for comparison. The blade 20 includes a thin strip of carbide material 22, which is not designed for re-sharpening. In contrast, blades according to the present disclosure may include a thicker strip of harder material to allow for multiple re-sharpenings or the creation of new teeth.

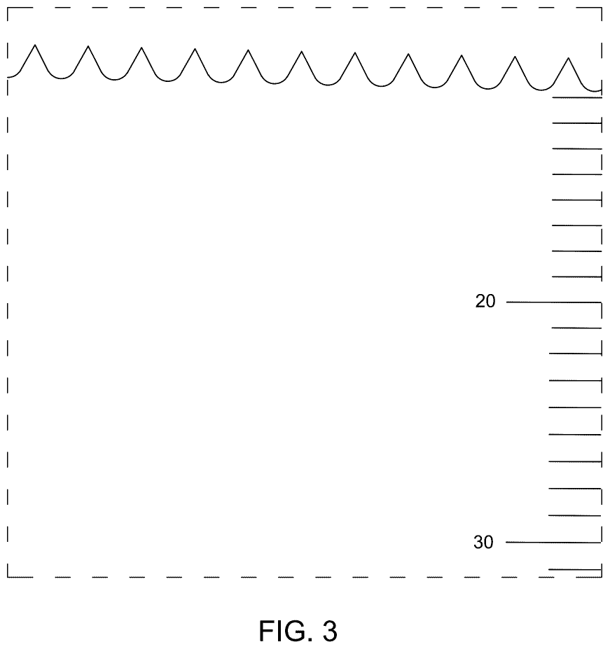

FIG. 3 shows a side view of a blade 30 according to an embodiment of the present disclosure. The blade 30 includes a blade body 32 and a strip of harder material 34. The depth D of the harder material 34 may be greater than one and a half times the height H of original blade teeth. This extended depth of harder material may allow for multiple re-sharpenings or the creation of new teeth throughout the life of the blade.

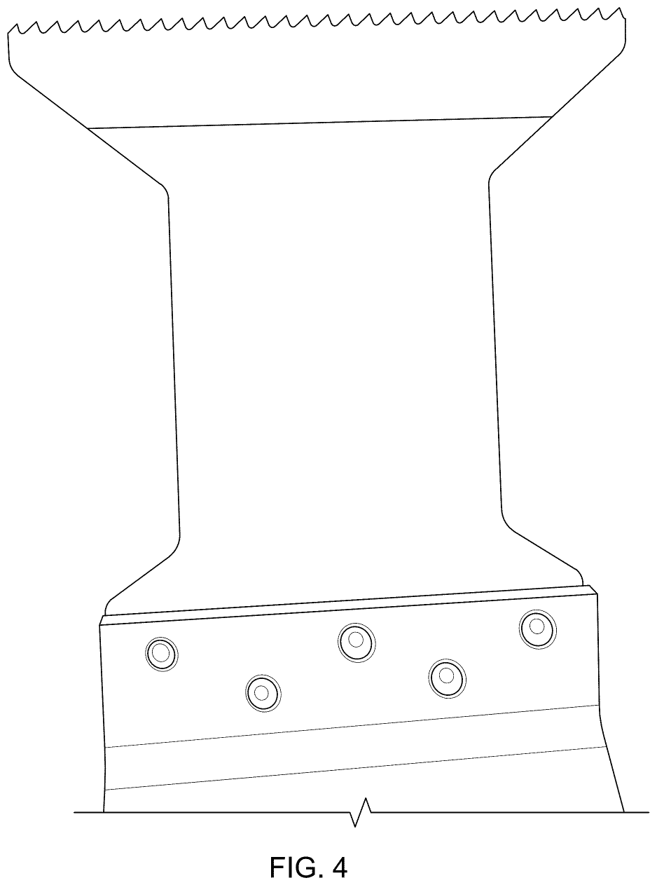

FIG. 4 depicts a conventional bi-metal blade 40 for comparison. The blade 40 includes a limited area 42 of high-speed steel, which is not designed for re-sharpening. In contrast, blades according to the present disclosure may include a deeper strip of harder or tougher material to allow for repeated sharpening or shaping of new teeth.

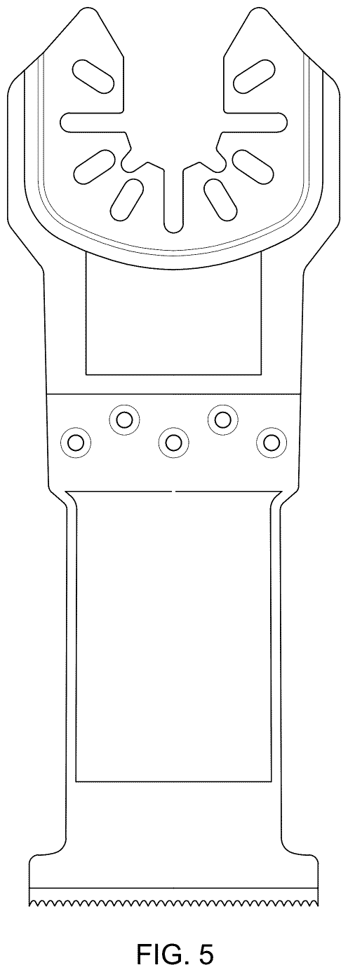

FIG. 5 shows a typical carbide oscillating multi-tool blade 50 for comparison. The blade 50 includes only a thin strip of carbide material 52, which is not designed for re-sharpening. Blades according to the present disclosure may include a thicker strip of harder material to enable multiple re-sharpenings or the creation of new teeth.

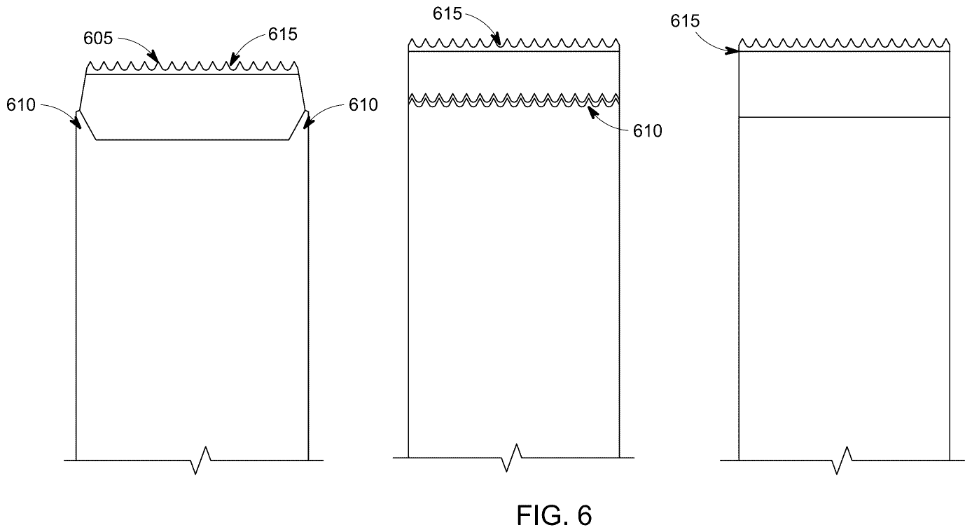

FIG. 6 may illustrate various non-linear mating surfaces between a blade body and a harder material used for teeth. The figure may show three vertical bars (605, 610, 615) with different configurations of non-linear interfaces. The first bar 605 may depict a non-linear pattern along the top edge where teeth may be formed. This non-linear interface may create a larger bonding surface between the blade body and the harder tooth material. The second bar 610 may show a brazed carbide strip attached to the top portion of the blade body. The interface between the carbide strip and blade body may have a non-linear pattern to increase the bonding surface area and better distribute loads. The third bar 615 may illustrate another variation of a non-linear mating surface between the blade body and tooth material.

These non-linear interfaces may help reduce the chances of the harder tooth material shattering from shock loads during cutting by allowing better energy transfer to the blade body. The increased bonding surface may be especially useful for attaching larger strips of carbide or other hard materials to oscillating blade ends. The non-linear patterns may take various forms such as wave shapes, interlocking geometries, or other irregular interfaces that increase surface area compared to a linear joint. This may allow for stronger bonding and improved load distribution between the dissimilar materials of the blade body and cutting teeth.

In some embodiments, the blades may be subjected to cryogenic treatment to enhance their durability and performance. Additionally, secondary coatings may be applied to the blades to further extend their life or reduce friction during use. In certain embodiments, the blade body may be designed to accommodate replaceable teeth, strips of teeth, or replaceable material designed for shaping new teeth. This modular approach may further extend the useful life of the blade and allow for customization based on specific cutting requirements. The blades described herein may be used with various oscillating multi-tools and reciprocating saws known in the art. The ability to re-sharpen or create new teeth may significantly extend the life of the blade, potentially reducing costs and waste associated with frequent blade replacements.

It should be understood that the embodiments described herein are exemplary and that a person skilled in the art may make many variations and modifications without departing from the spirit and scope of the disclosure. All such variations and modifications are intended to be included within the scope of the disclosure as defined in the appended claims. While illustrative embodiments of the invention have been shown and described, variations and alternative embodiments may occur to those skilled in the art. Such variations and alternative embodiments may be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for. . . ”.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

What is claimed is:

1. An oscillating multi-tool blade comprising:
a blade body; and
a bonded material for cutting teeth harder than the blade body, wherein a total depth of the bonded material is greater than one and a half times a height of original blade teeth.

2. The oscillating multi-tool blade of claim 1, wherein the bonded material comprises high-speed steel, tungsten carbide, or a material harder than the blade body.

3. The oscillating multi-tool blade of claim 1, wherein the blade body is designed for resharpening or reshaping of the cutting teeth after the original teeth are dull, worn down, or broken.

4. The oscillating multi-tool blade of claim 1, wherein the blade is initially created with no teeth, allowing a user to create custom blade teeth.

5. The oscillating multi-tool blade of claim 1, wherein the blade body is designed for replaceable teeth, a strip of teeth, or replaceable material for shaping new teeth.

6. The oscillating multi-tool blade of claim 1, wherein the blade is cryofrozen.

7. The oscillating multi-tool blade of claim 1, wherein the blade has a secondary coating for added blade life or friction reduction.

8. A reciprocating saw blade comprising:
a blade body; and
a bonded material for cutting teeth harder than the blade body, wherein the blade is designed for resharpening or reshaping of the cutting teeth after original teeth are dull, worn down, or broken.

9. The reciprocating saw blade of claim 8, wherein the bonded material comprises high-speed steel, tungsten carbide, or a material harder than the blade body.

10. The reciprocating saw blade of claim 8, wherein the blade is initially created with no teeth, allowing a user to create custom blade teeth.

11. The reciprocating saw blade of claim 8, wherein the blade body is designed for replaceable teeth, a strip of teeth, or replaceable material for shaping new teeth.

12. The reciprocating saw blade of claim 8, wherein the blade is cryofrozen.

13. The reciprocating saw blade of claim 8, wherein the blade has a secondary coating for added blade life or friction reduction.

14. A method of manufacturing a resharpenable saw blade, the method comprising:
constructing a blade body;
bonding a material harder than the blade body to the blade body for cutting teeth; and
ensuring a total depth of the bonded material is greater than one and a half times a height of original blade teeth.

15. The method of claim 14, further comprising creating the blade with no initial teeth.

16. The method of claim 14, further comprising designing the blade body for replaceable teeth, a strip of teeth, or replaceable material for shaping new teeth.

17. The method of claim 14, further comprising cryofreezing the blade.

18. The method of claim 14, further comprising applying a secondary coating to the blade for added blade life or friction reduction.

19. The method of claim 14, wherein the blade is an oscillating multi-tool blade.

20. The method of claim 14, wherein the blade is a reciprocating saw blade.

21. The oscillating multi-tool blade of claim 1, wherein the blade body and the bonded material have a non-linear mating surface.

22. The oscillating multi-tool blade of claim 21, wherein the non-linear mating surface comprises a wave pattern.

23. The oscillating multi-tool blade of claim 21, wherein the non-linear mating surface comprises a sawtooth pattern.

24. The oscillating multi-tool blade of claim 21, wherein the non-linear mating surface increases bonding strength between the blade body and the bonded material.

25. The reciprocating saw blade of claim 8, wherein the blade body and the bonded material have a non-linear mating surface.

26. The reciprocating saw blade of claim 25, wherein the non-linear mating surface comprises a wave pattern.

27. The reciprocating saw blade of claim 25, wherein the non-linear mating surface comprises a sawtooth pattern.

28. The reciprocating saw blade of claim 25, wherein the non-linear mating surface increases bonding strength between the blade body and the bonded material.

29. The method of claim 14, further comprising forming a non-linear mating surface between the blade body and the bonded material.

30. The method of claim 29, wherein forming the non-linear mating surface comprises creating a wave pattern or a sawtooth pattern.
